(19) United States
(12) Patent Application Publication
(10) Pub. No.: US 2024/0342048 A1
(43) Pub. Date: Oct. 17, 2024

(54) Spine Extension Roller

(71) Applicants: Thomas Walter Drath, Phoenix, AZ (US); Daniel Albert Drath, Phoenix, AZ (US)

(72) Inventors: Thomas Walter Drath, Phoenix, AZ (US); Daniel Albert Drath, Phoenix, AZ (US)

(21) Appl. No.: 18/752,570

(22) Filed: Jun. 24, 2024

Related U.S. Application Data
(63) Continuation-in-part of application No. 16/946,761, filed on Jul. 6, 2020, now Pat. No. 12,029,700.
(63) Continuation-in-part of application No. 15/142,311, filed on Apr. 29, 2016, now Pat. No. 10,702,446.

(51) Int. Cl. A61H 15/00

(52) U.S. Cl. CPC A61H 15/0092; A61H 2015/0014; A61H 2201/0119; A61H 2203/0456; A61H 2205/081

(57) ABSTRACT

The invention is embodied in an apparatus for extending the human back. The preferred apparatus has a frame of transverse and longitudinal members, and a roller 20 rigidly supported from below by a transverse member. The space above the roller and frame is open so that a user can lie face up on the roller and grab the longitudinal members with each hand to extend the back over the top of the roller. The user then lowers his hips to extend the spine as much as desired. The user can roll the spine, vertebrae by vertebrae, from the base of the occipital to the sacrum.

### FIELD OF THE INVENTION

The present invention relates to rolling and extending the spine.

### BACKGROUND

Foam rolling is a common technique and its benefits are well known. When foam rolling the back, a user will lie face up on a cylindrically-shaped foam roller with the roller oriented to roll lengthwise along the spine. The user may use the feet to assist moving the spine lengthwise over the foam roller. (See, e.g., FIG. 1.) While the benefits of foam rolling the back in this way are tangible, they are limited because a user's weight is distributed along the length of the roller. Once the user's body adjusts to the user's weight on the roller the benefits, while still tangible, diminish over time.

What is needed is an improved spine roller that can load the facet joints more directly and to a greater degree in order to provide additional benefits to a user beyond what the user could do with a foam roller alone.

### SUMMARY OF THE INVENTION

This invention comprises two key elements: (1) the roller and (2) the grab bars. When combined as described herein, the invention provides its user with a more effective method of positively manipulating the spine's facet joints and achieving spinal extension. In addition, this invention allows a user to mobilize the entire length of the spine, from the base of the occipital to the sacrum.

The spatial relationship between the roller and the grab bars allow a user to dynamically increase spinal extension as shown in FIGS. 2-3. By holding on the grab bars while dropping the hips, a user can self-achieve greater levels of facet manipulation, thereby allowing a user more effective results in a shorter period of time. Without grab bars, one simply cannot effectively counterbalance the spinal flexion that is invariably imposed on the human body functioning in a primarily sedentary culture.

The roller/grab bar combination enables a user to re-establish more favorable spinal facet extension in (a) a horizontal closed kinetic chain environment and (b) a non-compressive spinal loading environment (see FIGS. 2-3). This environment provides a user with more control as the user attempts greater range of motion in the facet joints. Typical standing and back-bending environments common in yoga and other practices are performed in open kinetic chain and under spinal load, and with inherently less user control.

### BRIEF DESCRIPTION OF THE DRAWINGS OR PICTURES

FIG. 1 illustrates a prior art device.

FIG. 2 illustrates a side view of a person using a preferred embodiment of the apparatus 5.

FIG. 3 illustrates of a top view of a person using a preferred embodiment of the apparatus 5.

FIG. 4 illustrates a front perspective view of a preferred embodiment of the apparatus 5.

FIG. 5 illustrates a top view of a preferred embodiment of the apparatus 5.

FIG. 6 illustrates a side view of a preferred embodiment of the apparatus 5.

FIG. 7 illustrates a side view of a preferred embodiment of the apparatus 5.

FIG. 8 illustrates an exploded view of a preferred roller assembly.

FIG. 9 illustrates a front view of an embodiment of a roller assembly.

FIG. 10 illustrates a front perspective view of an optional embodiment of the apparatus 5.

FIG. 11 illustrates a rear perspective view of the optional embodiment of FIG. 10.

FIG. 12 illustrates a front perspective view with the front legs in a retracted position.

FIG. 13 illustrates a rear perspective view with the front legs in a retracted position.

FIG. 14 illustrates a rear perspective view with the front legs in a folded position.

FIG. 15 illustrates a side view of the optional embodiment with the front leg in a folded position.

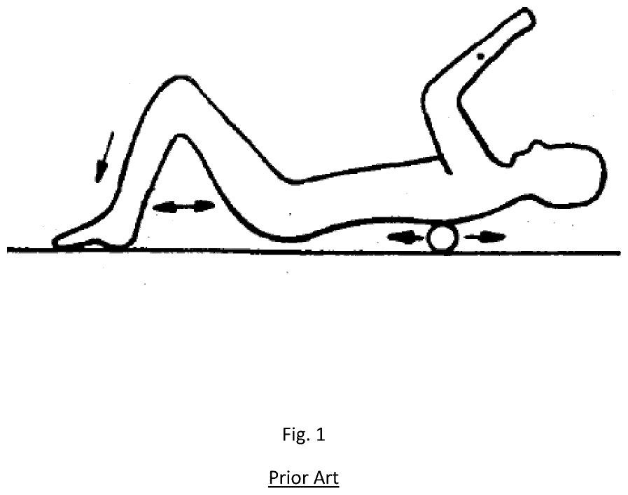

### DETAILED DESCRIPTION

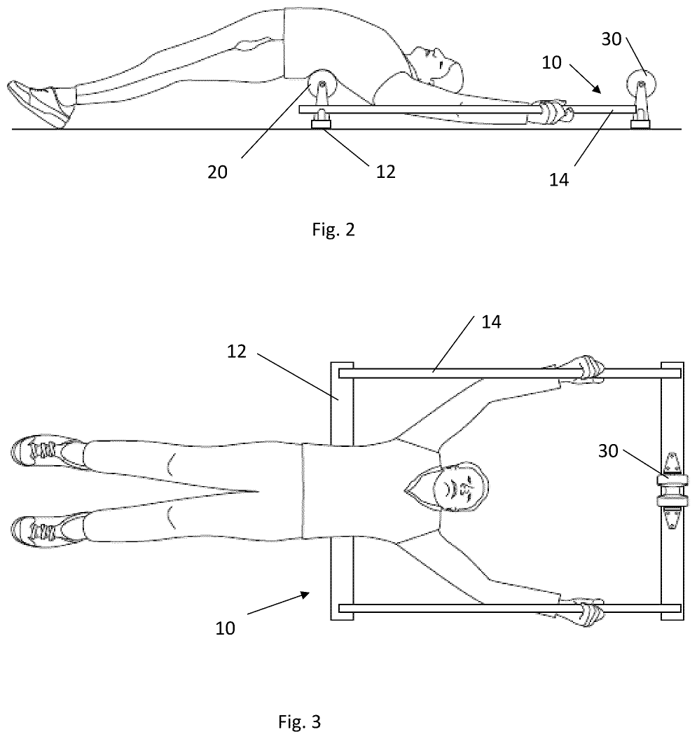

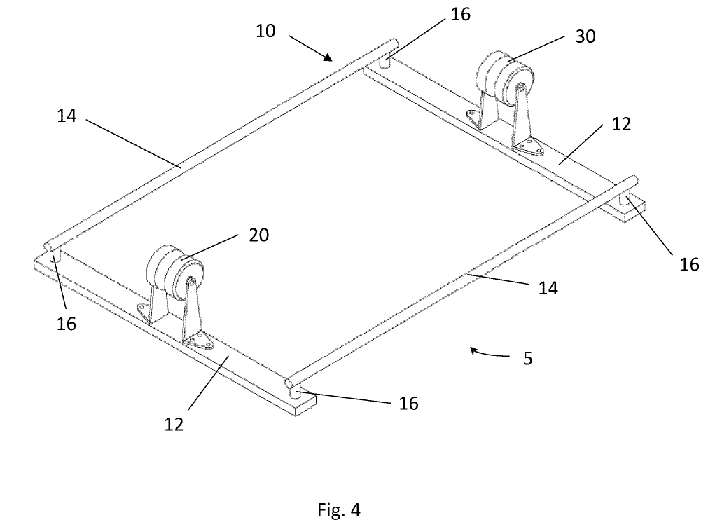

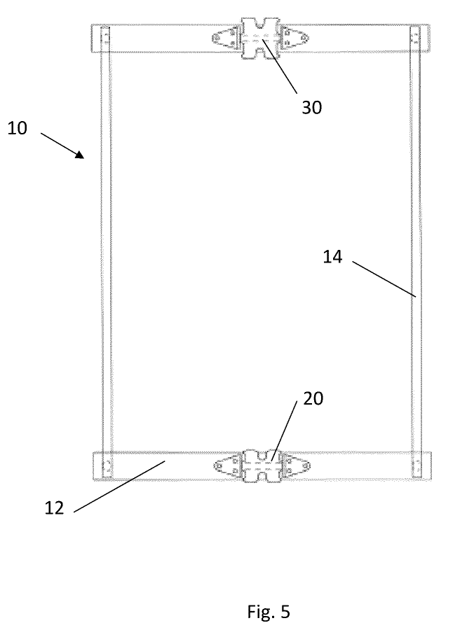

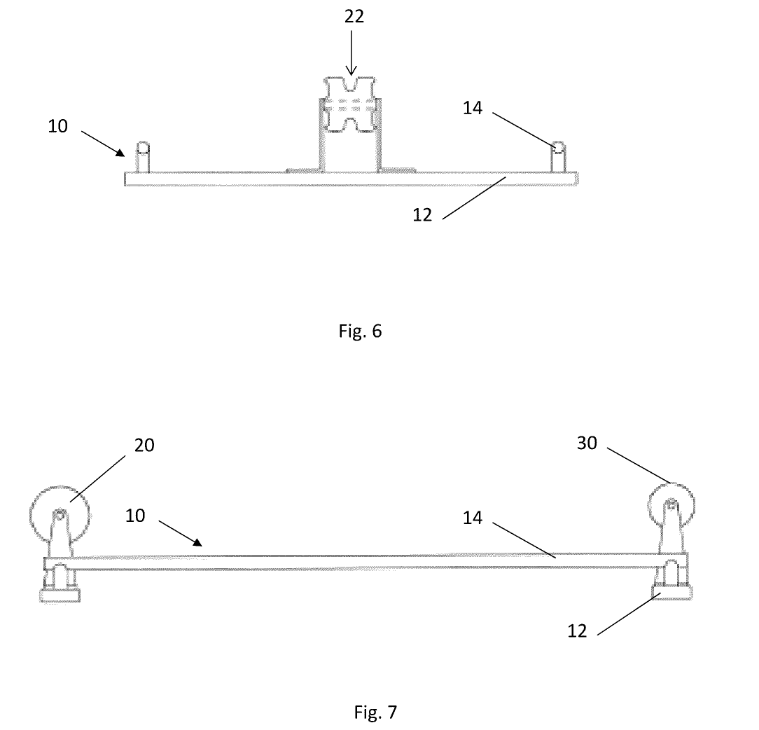

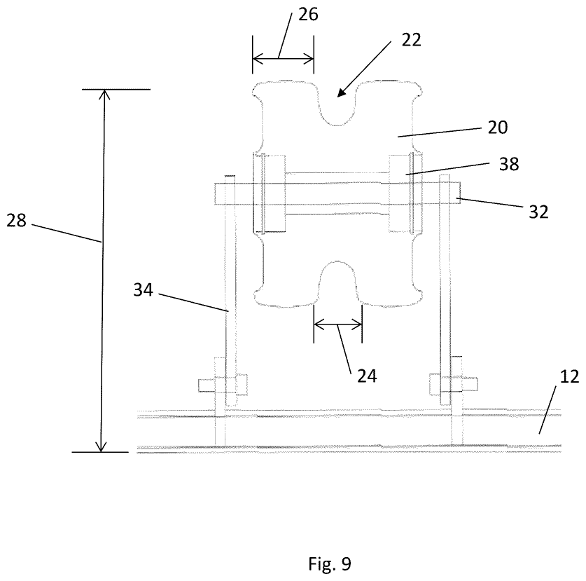

The invention is embodied in an apparatus for extending the human back. As shown in FIGS. 2-9, the preferred apparatus has a frame 10, comprising transverse members 12 and longitudinal members 14. A roller 20 is rigidly supported from below by the transverse member 12. The space above the roller 20 and frame 10 is open so that a user can lie face up on the roller and grab the longitudinal members 14 with each hand to extend the back over the top of the roller as illustrated in FIG. 2-3. The user then lowers his hips to extend the spine as much as desired. The user can roll the spine, vertebrae by vertebrae, from the base of the occipital to the sacrum.

The preferred frame 10 is constructed from steel members bolted together, although welding or most any connection known in the art would suffice. The transverse member 12 is preferably a rectangular tube. The longitudinal members 14 are preferably circular tubes connected to the top sides of transverse members 12 at joints 16. Connecting the longitudinal members 14 to the top sides of the transverse members 12 creates a space under the longitudinal members 14 when the transverse members 12 are resting on the ground or floor. This space allows a user of the apparatus to grab each longitudinal member 14 while using the apparatus. The preferred frame is 48″ (inches) by 32″. The frame 10 could be collapsible for easy storage if desired. There are many ways to construct a collapsible frame known in the art. One example is to add locking hinges on two of the joints 16 and latches on the remaining two joints 16 so that the frame can be collapse and stored in the collapsed position. Alternatively, one or more of the members, like the longitudinal members, could be a telescoping member so its length could be shortened for easier storage.

The preferred roller 20 is made from polyvinyl chloride (pvc), but any rigid material will work. The roller rotates about an axis substantially perpendicular to the longitudinal members to that a user's hand can travel up and down the longitudinal member as the user moves the length of his or her back over the roller.

The preferred roller 20 has an open channel 22 that runs around the circumference of the roller 20. The channel is oriented substantially parallel to the longitudinal members so that when the user is face-up on the roller 20, the spinous process passes through the open channel and the surface 21 of roller 20 rest over the facet joints, not on the spinous process part of the vertebrae.

The dimensions of the roller can vary greatly to suit a user's preference, but a roller 20 between 2″ (inches) and 6″ in diameter, and preferably between 3.5″ and 4.5″, has been found to work well. Likewise, a channel 22 having width 24 that is 1″ wide and a depth of 1″ deep is preferable. A roller width 26 on either side of the channel that is preferably 1.5″ wide has been found to work well. The preferable height 28 between the top of the roller and the floor is between 3″ and 12″ with 8″ being most preferred.

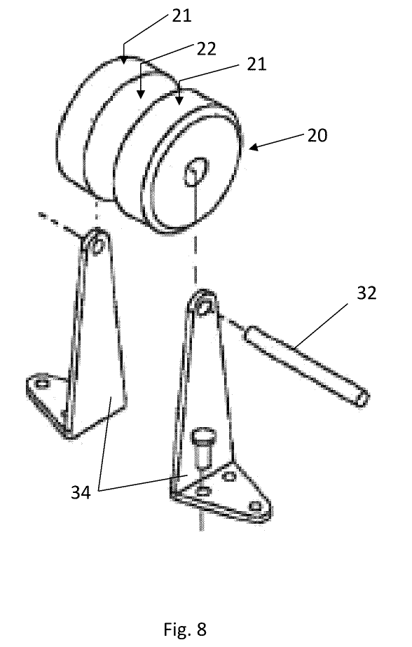

The preferred roller spins on a shaft 32. The shaft 32 is supported on either end by vertical members 34. The vertical members 34 are connected to the frame 10, preferably by welding, but other connections like bolting as shown in FIG. 8 are suitable. Optionally, on a pair of roller bearings 38 can be added but have been found unnecessary.

Additionally, the width of the roller 10 allows a user to mobilize the body's scapula. All of these elements of the spine are associated with the idea of movement within each segment of the spine. This is important for reasons of optimally nourishing the spinal disks, while also allowing the appropriate levels of innervation throughout the entire body that begins at each segment of the vertebra.

An optional second roller 30 can be mounted just like the first roller 20 on the opposite traverse member 12 from the first roller 20. This optional second roller 30 could have different dimensions than the first roller 20 or could be located higher or lower than the first roller 20 to provide a user two different rolling options in one device. Either way, the second roller 30 is not required to practice the invention.

### Optional Embodiments

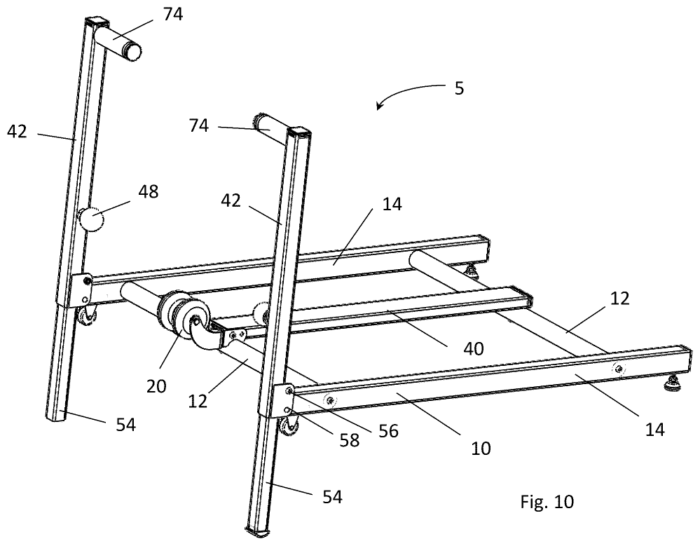

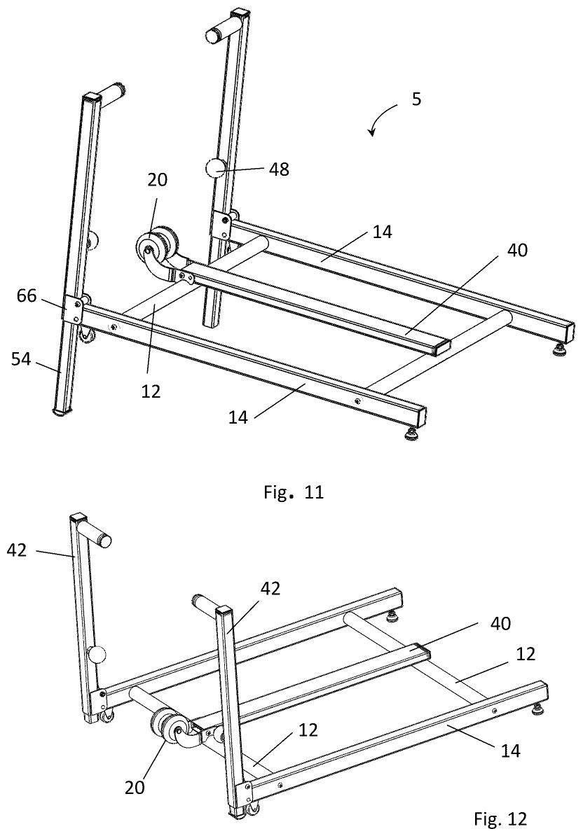

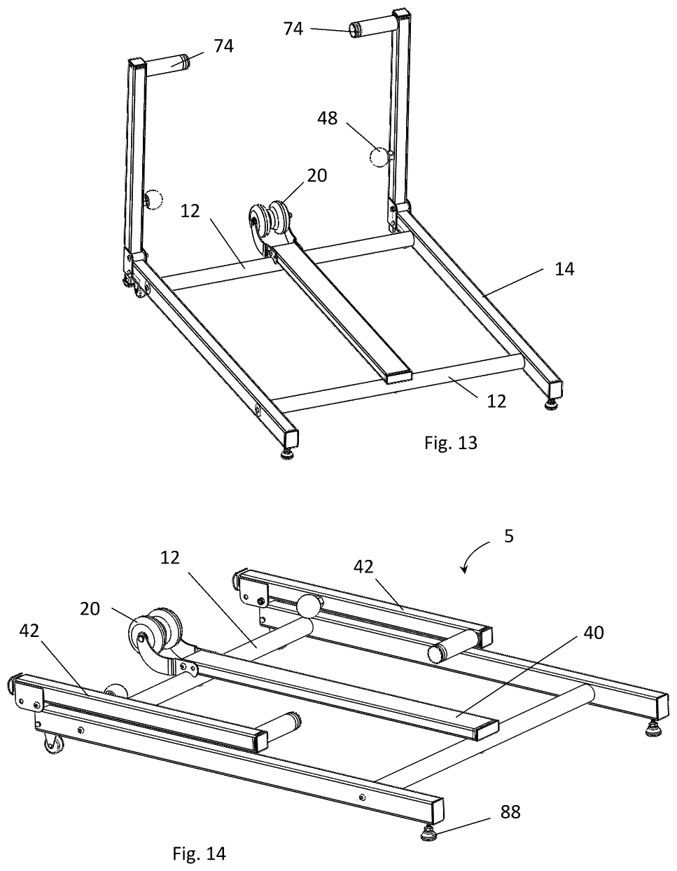

FIGS. 10-15 illustrate an optional embodiment that can provide additional features and enhancements. For example FIG. 10 illustrates a frame 10, comprising transverse members 12, longitudinal members 14, and roller 20. In addition, FIG. 10 also illustrates an interior longitudinal member 40. This interior longitudinal member 40 is preferably connected at the ends to the two transverse members 12. It is preferred to orient the interior longitudinal member 40 to run parallel to the longitudinal members 14. The preferred purpose of the interior longitudinal member is to stiffen the frame 10, provide a smooth surface to support a user's upper body during use and to provide structural support for the roller assembly 60.

Also shown in FIG. 10 are legs 42. Legs 42 are connected to frame 10. It is preferred that legs 42 can extend and contract so that a user can raise and lower the height of the transverse member (and corresponding, the roller 20) relative to the floor. The preferred way to enable extension/contraction of legs 42 is a telescoping segment 54. The telescoping segment 54 is configured to slide inside leg 42 and can be adjustably fixed via pop pin 48.

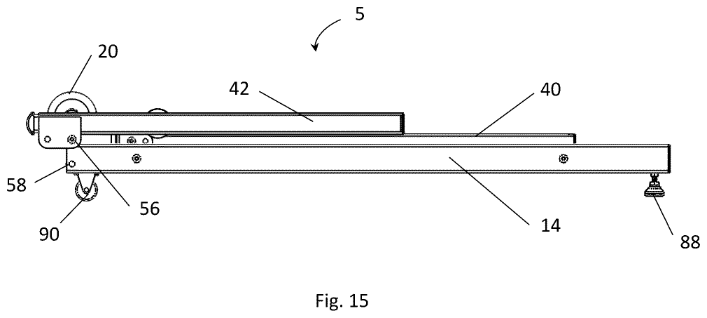

In addition, it is preferred to rotatably connect legs 42 to frame 10 via a pinned connection 56. A pinned connection 56 allows the legs 42 to fold down on top of the frame 10 as shown in FIGS. 14-15. When legs 42 are in a folded position, apparatus 5 can be stored (e.g., under a bed or in a closet) easily. Wheels 90 can be mounted to frame 10 to make it easier to move the apparatus around, either in a folded or unfolded position. There are many ways to make pinned connection 56. It is preferred to fix a bracket 66 to legs 42 (e.g., welding) and fix a pop pin 58 to frame 10 (e.g., welding) and let the legs 42 rotate about frame 10. Pop pin 58 can be connected to frame 10 to fix the legs 42 (preferably to the bracket 66) in the unfolded position. While these figures illustrate the preferred connection, those in the art will recognize various ways to achieve this rotating-leg, two position functionality.

Another optional embodiment is to position a pair of handles 74 above the frame 10 so that a user can grab the handles when using the roller 20. There are many ways to achieve this. It is preferred that legs 42 extend above frame 10 so that handles 74 can be mounted directly to legs 42 as shown.

The preferred way to store the apparatus 5 is to release pop pins 58 and rotate the handle assembly 70 toward the corresponding longitudinal member 14 so that it fits within (or on top of) the longitudinal member 14 as shown in FIGS. 14-15. Likewise, releasing pop pins 58 allows the legs 42 to rotate relative to the longitudinal members 14 so the whole apparatus flattens as shown in FIGS. 14-15. This way the apparatus 5 can be easily stored under a bed or other storage area.

Other optional features include feet 88 to help keep the apparatus 5 from sliding relative to the floor and walls. Wheels 90 can assist in sliding for storage.

While the invention has been described by means of specific embodiments, modifications and variations could be made thereto by those ordinarily skilled in the art without departing from the scope and spirit of the invention set forth in the claims. Likewise, the invention is not limited in its operational application to the above details of mechanical angular and special relationships, users biomechanical positioning, various extremity force producing embodiments and of being practiced or of being potentially operationally carried out in various other ways. The phraseology and terminology used herein is for the purpose of description and should not be regarded as limiting.

What is claimed is:

1. A spine rolling apparatus comprising,
a frame, the frame comprising a first transverse member, a second transverse member, and two longitudinal members,
an interior longitudinal member positioned parallel the two longitudinal members and connected between the first transverse member and the second transverse member, and
a roller connected the interior longitudinal member and positioned on the opposite side of the first transverse member from a middle of the interior longitudinal member, the roller rotating around an axis parallel to a longitudinal axis of the first transverse member.

2. The apparatus of claim 1, further comprising a leg rotatably connected to one of the longitudinal members, the leg comprising a first position and a second position, wherein the first position is at least ninety degrees rotated from the second position.

3. The apparatus of claim 1, further comprising a leg connected to one of the longitudinal members, the leg comprising a telescoping segment that can adjust the height of the first transverse member off the ground.

4. The apparatus of claim 1, further comprising a leg connected to one of the longitudinal members, the leg comprising a section extending above the frame, and a handle connected to the section.

5. A spine rolling apparatus comprising,
a frame, the frame comprising a transverse member and three longitudinal members, the three longitudinal members extending from the transverse member, and
a roller assembly adjustably connected to a middle longitudinal member at the intersection of the transverse member, and
a leg connected to one of the longitudinal members, the leg rotatably connected to the longitudinal member.

6. The apparatus of claim 5, the leg comprising a first position and a second position, wherein the first position is at least ninety degrees rotated from the second position.

7. The apparatus of claim 5, the leg comprising a section extending above the frame, and a handle connected to the section.

8. The apparatus of claim 5, the leg comprising a telescoping segment that can adjust the height of the roller off the ground.

9. A spine rolling apparatus comprising,
a frame comprising a pair of transverse members and a pair of longitudinal members,
an interior longitudinal member connected between the transverse members oriented parallel the two longitudinal members,
a roller connected the interior longitudinal member, and
a leg connected to one of the longitudinal members, the leg comprising a telescoping segment that can adjust the height of the roller off the ground.

10. The apparatus of claim 9, the leg comprising a section extending above the frame, and a handle connected to the section.

11. The apparatus of claim 9, wherein the leg is rotatably connected to the longitudinal member.

12. The apparatus of claim 11, the leg comprising a first position and a second position, wherein the first position is at least ninety degrees rotated from the second position.
